(19) United States
(12) Patent Application Publication
(10) Pub. No.: US 2014/0245177 A1
(43) Pub. Date: Aug. 28, 2014

(54) GRAPHICAL USER INTERFACE FOR ENTERING MULTI-CHARACTER EXPRESSIONS

(71) Applicant: Edmund Raphael Lewis Maklouf, Surrey (GB)

(72) Inventor: Edmund Raphael Lewis Maklouf, Surrey (GB)

(73) Assignee: SIINE LIMITED, Surrey (GB)

(21) Appl. No.: 14/237,985

(22) PCT Filed: Aug. 9, 2012
(86) PCT No.: PCT/GB2012/051943

§ 371 Date: Apr. 21, 2014

Related U.S. Application Data
(60) Provisional application No. 61/522,890, filed on Aug. 12, 2011.

(30) Foreign Application Priority Data
Aug. 12, 2011 (GB) 1113928.4

(51) Int. Cl. G06F 3/0488

(52) U.S. Cl. CPC G06F 3/04886
USPC 715/752

(57) ABSTRACT

A system and method for receiving user input via a graphical user interface (GUI) to generate message text on an electronic communication device comprising a touch-sensitive electronic display. The touch-sensitive electronic display provides the user with a message composition interface. This message composition interface comprises a virtual alphanumeric keyboard having keys configured to receive a user input for composing message text character-by-character. The message composition interface is modified to display to the user an appropriate GUI module comprising graphical representations of predefined multi-character expressions. A user interaction with at least one of said graphical representations of the GUI module specifies at least one of said multi-character expressions. Text associated with the user-specified multi-character expression is inserted into the message as a result.

### TECHNICAL FIELD

The present invention relates to a method and system for receiving user input via a graphical user interface (GUI). The invention particularly relates to a method and system for receiving user input via a GUI to generate text on an electronic communication device comprising a touch-sensitive electronic display.

### BACKGROUND

Text input interfaces have evolved significantly since the invention of the typewriter. One of the most recent developments within computing and handheld devices such as mobile phones and tablets is the virtual keyboard. As is known in the art, an image of a keyboard is shown on a touch-sensitive electronic display that a user interacts with to tap out text character-by-character.

One consideration in this area that is particularly applicable to relatively small mobile devices is the arrangement of the keys on the virtual keyboard. Mobile devices tend to have limited screen-space, and so certain compromises need to be made when implementing virtual keyboards. Frequently, either the key set of the virtual keyboard is reduced, or the size of individual keys is reduced—both of which can adversely effect the accuracy and speed of text input.

Some mobile devices have dedicated hardware keyboards which are used to type out text. Hardware keyboards have the advantage of providing better tactile feedback to a user, promoting text entry accuracy and speed. The drawback of such hardware keyboards is that some of the physical space on the electronic device—which may normally accommodate a display—is sacrificed to provide such a hardware keyboard. Furthermore, hardware keyboards do not have the same versatility as virtual keyboards, which can be hidden or modified depending on the demands of an application running on the device.

In either case, the physical space over which to present the keys of a keyboard is pitched against the number of different characters required to compose text in a particular language. In many cases multiple characters may be assigned to an individual key, demanding that a user select that key more than once, or use a ‘shift’ or ‘function’ key to access the auxiliary characters. This further increases the number of keystrokes necessary to generate text.

Text prediction and completion engines can go some way towards alleviating the number of keystrokes required to generate text. However, such measures still require a user to approve or reject an automatically predicted word. Furthermore, the models used to drive such text prediction and completion engines tend to be built up progressively by a user through use of a text generation interface, which can take time to develop. An additional drawback is that such models suggest words based on the probability of word frequency and occurrence rather than the context of a message. Thus, if a user wants to enter a new word, the text prediction/completion engine is likely to incorrectly suggest an old word. These methods are limited mostly to word-by-word text composition, and cannot extend to phrase-by-phrase composition.

Other text input methods attempt to overcome the number of keystrokes required to enter words by altering the physical gesture needed to select a given key. For example, such modified text input methods may involve a user tracing a pathway over the keys of the virtual keyboard rather than tapping those key individually. Here, the user is still compelled to select the keys to form a word character-by-character, and furthermore can still suffer from the errors induced by limited key size and arrangement.

A further drawback associated with prior known text input methods is the lack of semantic information associated with the generated text. Such semantic information associated with user-generated text can be useful when performing automatic operations associated with that text. As all prior known text input methods tend to involve typing words or phases character-by-character the information value is low. Thus if the meaning behind a word or phrase is to be automatically determined, this must be done after the text has been generated. Therefore any process designed to correctly interpret the information content of a message must begin by analysing the words used and applying linguistic grammars and natural language analysis. This is not only computationally intensive, but also prone to errors.

It is against this background that the present invention has been devised.

### SUMMARY OF THE INVENTION

According to a first aspect of the present invention there is provided a method of receiving user input via a graphical user interface (GUI) to generate message text on an electronic communication device comprising a touch-sensitive electronic display, the method comprising:
providing the user with a message composition interface via the touch-sensitive electronic display, the message composition interface comprising a virtual alphanumeric keyboard having keys configured to receive a user input for composing message text character-by-character;
modifying the message composition interface to display to the user an appropriate GUI module comprising graphical representations of predefined multi-character expressions;
receiving a user interaction with at least one of said graphical representations of the GUI module thereby specifying at least one of said multi-character expressions; and
inserting text associated with the user-specified multi-character expression into the message.

Preferably, the method comprises receiving a trigger, and in response modifying the message composition interface to display to the user an appropriate GUI module. Preferably, receiving a trigger comprises receiving a user selection of a function key of the message composition interface and in response modifying the message composition interface to invoke an appropriate GUI module comprising graphical representations of predefined multi-character expressions. Ideally, when invoked, the GUI module replaces said virtual alphanumeric keyboard at least in part.

Thus, the method provides an improved way of generating text that provides an advantageous balance between flexibility and speed. It does this by complementing a message composition interface that allows the user to generate text flexibly character-by-character (e.g. via a keyboard) with an appropriate GUI (Graphical User Interface) module that can be operated to generate multi-character expressions. These multi-character expressions may be words, multi-word phrases or even expressions of time, date, people, places, verbs, activities and/or location etc. Thus, a user is able to compose a message more quickly because the user is not confined to character-by-character text input, but rather is able to insert multi-character expressions at a time. For example, the GUI module can provide shortcuts to whole words, phrases, sentences and/or even paragraphs of text, thereby avoiding the need to type those words out letter by letter. It will also be noted that even though a GUI module is available for use in generating multi-character expressions, the user is not confined to using the GUI module, and can still fall back onto using a character-by-character input interface.

For the avoidance of doubt a character-by-character input method or “standard keyboard” may involve a variety of different layouts of letter keys, number keys and punctuation keys. For example, in different countries, different key layouts may be used. However, the complementary use of a GUI module permitting multi-character expression insertion is beneficial regardless of whichever one of the different character-by-character keyboards is used.

Advantageously, multi-character expressions are specified by the user interacting with graphical representations. Therefore, these expressions can be specified and inserted into the message in a single operation, or at least fewer operations than if those expressions were typed by a user character-by-character.

The graphical representations may comprise non-textual representations.

Such non-textual representations may include icons, signs, dials, slider and/or other GUI artefacts. The graphical representations may be shaped and arranged for visually distinguishing individual graphical representations. The graphical representations may comprise indicia for visually distinguishing individual graphical representations. The graphical representations may comprise non-textual indicia for visually distinguishing individual graphical representations.

Advantageously, this can improve the user's interaction, rate of understanding and operation of the GUI module to select a desired multi-character expression—more so than if those multi-character expressions were represented by text alone.

A further advantage is that this process of text composition is more aligned to the internal psychological construction of a message “idea” for a human user, making the action of producing text more comfortable and intuitive. Furthermore, substantially more information is communicable to the user via non-textual graphical representations.

Preferably, graphical representations are visually delimited from one another. For example, individual graphical representations can be separated from one another by lines, boundaries and/or boxes. The graphical representations may be visually delimited from one another by utilising contrasting colours and/or shades. Advantageously, this can enhance a users understanding of how to operate said graphical representations.

A further advantage that improves the interaction between the user and the device is associated with receiving a trigger to invoke an appropriate GUI module only when it is required. Thus resources such as display space occupied are not wasted on displaying inappropriate GUI modules. By contrast, if a GUI module (or multiple GUI modules) were to be presented to the user as a permanent feature of the message composition interface, the message composition interface could become overly cluttered. This can confuse the user, slowing message generation.

Preferably, the method comprises applying an intelligent filter based on the context of a message. Preferably, the intelligent filter controls the invocation of an appropriate GUI module. The intelligent filter may restrict the invocation of an inappropriate GUI module. Furthermore, the intelligent filter may control which graphical representations are show within an appropriate GUI module. Thus, the GUI modules and GUI module components remaining are likely to be those which are the most likely needed.

Preferably, the communication device is a mobile communication device. Mobile communication devices tend to have electronic displays of limited size. This is especially true when these devices are pocket-sized telecommunication handsets such as smart-phones. Accordingly, the area in which to display a GUI module—as well as other components of the message composition interface (e.g. text display area, virtual keyboard)—is very limited. Additionally, if the device comprises a touch-screen display, then virtual keys and graphical representations such as icons, dials and sliders must be of a minimum size to allow a user's finger to operate them practically and comfortably. Accordingly, it will be appreciated that the present invention is particularly applicable to handheld mobile telecommunication devices having touch-sensitive electronic displays due to the space saving that can be realised through a triggered GUI module. Thus, it is preferable that the method comprises receiving a user interaction with the graphical representations via a touch-sensitive electronic display.

Preferably, the method comprises receiving a user interaction with a plurality of graphical representations of the GUI module thereby specifying a plurality of multi-character expressions in sequence. Advantageously, this can quickly generate long strings of text.

Preferably, the user interaction with a graphical representation may comprise selecting it, for example using a tap or a click. Ideally, a user interaction with a graphical representation may comprise repeatedly selecting the same graphical representation. Preferably, repeatedly selecting a graphical representation specifies a series of alternative multi-character expressions. Ideally, after each selection of a graphical representation the specified multi-character expression—or its alternative—is displayed to the user. Thus this can provide feedback to the user about which multi-character expression is to be inserted into the message.

Advantageously, this allows a user to easily specify one of a number of multi-character expressions that may have semantically associated meanings, or may be of the same meaning, but represented textually in different formats. Advantageously, this allows a user to select the most suitable multi-character expression. For example, if a graphical representation is associated with a multi-character expression associated with a greeting, repeating selecting that same graphical representation can cycle through a number of different styles of greetings—e.g. “Hello”, “Hi”, “Hi there”, “Bonjour”, “Greetings”, “Salutations”, “Yo” etc.

Preferably, the method comprises displaying a customisation module to a user, the customisation module being configured to receive a user assignment of a graphical representation with at least one multi-character expression. Advantageously, this allows a user to customise which one or more multi-character expressions are associated with a given graphical representation.

Preferably, the method comprises determining multi-character expressions that are frequently inserted by a user into messages, automatically creating a graphical representation of that multi-character expression, and providing said automatically created graphical representation of that multi-character expression within an appropriate GUI module. Preferably, automatically creating a graphical representation of a high-frequency user-inputted multi-character expression may comprise querying an image library with that multi-character expression and then picking an appropriate image from that library. Meta-data relevant to the context of when said high-frequency user-inputted multi-character expressions are likely to be inserted into a message may be associated with said automatically created graphical representation.

Preferably, the customisation module is configured to present to a user a library of graphical representations. Preferably, the customisation module is configured to receive a user selection of a graphical representation within that library. Preferably, the customisation module is configured to prompt the user to assign one or more multi-character expressions with said graphical representation selected from the library. Preferably, the customisation module is configured to add said assigned graphical representation to a GUI module for use in generating text during message composition. Advantageously, this allows a user to choose appropriate graphical representations for association with user-defined multi-character expressions.

Preferably, the customisation module comprises a graphical representation editor arranged to receive a user interaction to edit and/or generate graphic representations. Preferably, the customisation module is configured to save said edited or user-generated graphical representations to said library of graphical representations. For example, the graphical representation editor may comprise an icon editing module. Advantageously, this allows a user to create a personalised graphical representation that may subsequently be assigned to a multi-character expression. This allows the user to not only choose, but rather create a graphical representation of a multi-character expression that may be personal or unique to the user.

Preferably, the customisation module comprises a GUI module editor arranged to receive a user input to create one or more personal GUI modules. Preferably said personal GUI modules comprises user-define graphical representations of multi-character expressions. Advantageously, this lets a user define GUI modules that may be appropriate for contexts that are relevant to the user. For example, a waiter or waitress may want to create a GUI module containing graphical representations of food and drink orders. Thus, instead of writing out each item of an order, character-by-character, it is possible to quickly enter each item of an order by selecting the appropriate custom-made graphical representation.

As mentioned, the message composition interface can be modified to replace said virtual alphanumeric keyboard—at least in part—with an appropriate GUI module comprising graphical representations of predefined multi-character expressions. This can be done in response to a user selection of a function key of the message composition interface (e.g. a key on the virtual keyboard). However, the method may comprise receiving another trigger for invoking an appropriate GUI module. This may be in place of the function key, or in complement with it. In particular, the trigger may be a user-driven trigger and/or an automatic trigger.

Preferably, the step of receiving a trigger comprises receiving an input from the user to signify an appropriate GUI module to be presented. The step of receiving a trigger may comprise displaying a menu to the user containing user-selectable shortcuts, a user selection of a shortcut signifying an appropriate GUI module to be presented. The menu and/or shortcuts may be provided via the message composition interface.

Advantageously, a user-driven invocation of a GUI module prevents the standard message composition interface from being modified automatically against the intuition or desire of the user. This prevents the user from being confounded by an unexpectedly changing message composition interface. Rather the user can indicate when and which particular GUI module is to be invoked.

The method may comprise receiving an automatic trigger for use in invoking an appropriate GUI module. The automatic trigger may be generated in response to analysing a message concurrently with message generation to detect a predetermined phrase therein.

Advantageously, an automatic determination can be made as to whether the invoking of a particular GUI module is appropriate, and this is done with consideration being made to the context of the message. Predetermined phrases within a message can be associated with a particular GUI module so that when a user interacts with that GUI module, an expression can be inserted into the message which is an appropriate accompaniment to the predetermined phrase. For example, if the predetermined phrase is “I'll be there by”, then an appropriate GUI module to be invoked is one allowing a user to insert an expression of time into the message. For example, “3 pm” or “5th of August” or “next week” could be inserted into the message after the predetermined phrase “I'll be there by”—and this can be effected via user interaction with graphical representations of those expressions of the appropriate GUI module. Thus GUI modules are available for invocation intelligently in response to what is typed so that the screen area will be occupied by only an appropriate GUI module. It should be noted that this presents an advantage over prior known “text prediction” algorithms. Rather than completing an item of text being typed, or even attempting to predict the next word, a context-appropriate category of possible expressions may be presented to a user via the GUI module. Accordingly, message composition flexibility is retained.

The method may comprise learning said predetermined phrases, and associated GUI modules to be automatically invoked, from a user input. Preferably, the method comprises receiving a user-driven invocation of a given GUI module and logging message text entered prior to said user-driven invocation, said logged message text being used as a predetermined phrase for automatically invoking the given GUI module in future message composition.

Advantageously, it is thus possible to teach when a GUI module should automatically appear in response to a phrase entered by a user. This allows predetermined phrases to be customised to a user's individual use of language. For example, if a user always uses the phase “Let's touch base at” prior to manually invoking a GUI module to insert an expression of time, it is possible for this phrase to be learnt and stored as a predetermined phrase for future use to automatically invocate that GUI module. Furthermore, context meta-data associated with that phrase can also be stored. Advantageously, this obviates the user needing to manually invoke that GUI module every time that phrase is used.

Preferably, the method comprises suggesting an appropriate GUI module to a user in response to detecting a predetermined phrase.

This retains the benefit of preventing the message composition interface being altered significantly whilst also providing the advantage of assisting the user in deciding when a appropriate GUI module is available for use, and the range of expression available through that GUI module. For example, if a predetermined phrase is detected, a shortcut to an appropriate GUI module may be highlighted. This will not interrupt the arrangement of the message composition interface, but can still alert the user to the fact that a GUI module may be used to insert a relevant expression.

Preferably, a GUI module is associated with a predetermined semantic category and comprises graphical representations of predefined multi-character expressions that are each semantically associated with the predetermined semantic category. The graphical representations of multi-character expressions may be arranged within the GUI module in dependence on their association with a semantic sub-categories and/or semantic relationship to one another. By way of example, a GUI module associated with time may comprise a graphical representations belonging to different semantic sub-categories such as: days of the week (e.g. Monday, Tuesday, Wednesday etc.), specific calendar date (e.g. 3rd August 2011) or time of day (e.g. 15:00, 3 pm, noon etc.).

Preferably, where there are a plurality of GUI modules, each is associated with a different predetermined semantic category. A semantic category may be one of time, location, activity, people, greetings, sign-offs/goodbyes, swearing, or another such category.

Advantageously, a GUI module associated with a particular semantic category is more intuitive for a user to understand. Furthermore, expressions provided through a semantically categorised GUI module mean that when the GUI module is invoked, there is good chance that the multi-character expression that a user wishes to insert into the message (or at least a similar expression) is available. For example, if a GUI module is associated with the category of time, then an expression of time that the user would like to include in a message (e.g. “3 pm”, “5 August”, “tomorrow”, “next week” etc) can be easily composed into text from those readily available.

A further advantage associated with predetermined semantic categories may be realised when the method comprises receiving a user interaction with a plurality of graphical representations of the GUI module to specify a plurality of multi-character expressions in sequence. As graphical representations associated with a particular semantic category are grouped together, this increases the likelihood that a sequence of multi-character expressions that a user wants to insert into the message can be specified from a common GUI module. For example, if the GUI module is associated with time, then a sequence of graphical representation are available for selection within this GUI module to specify a time period. E.g. “from”, “2”, “:15”, “pm”, “until”, “3”, “:30”, “pm”.

Preferably, the method comprises amending text pre-entered character-by-character when an expression is user-specified via an appropriate GUI module. Advantageously, this can automatically correct the grammatical structure of a sentence within a message, obviating the need for a user to go back to correct a message as a result of an expression inserted into the message via the GUI module. For example, if the user types the phrase “I'll be there at” and a GUI module is invoked to insert an expression of time, depending on the expression chosen, it may be appropriate to amend the pre-entered phrase. If the chosen expression is “3 pm”, then there is no need to amend the phrase. If the chosen expression is “Tuesday”, then it would be appropriate to amend the phrase so that the message reads “I'll be there on Tuesday” instead of “I'll be there at Tuesday”.

Preferably, the predefined multi-character expressions are associated with pre-defined meta-data. Ideally, the meta-data contains semantic information about a respective multi-character expression for use in interpreting the meaning of that multi-character expression. Ideally, when multi-character expressions are specified by a user to be inserted into a message, respective meta-data is also recorded and may be linked to the message. For example, meta-data may be appended to or embedded within the message. Alternatively, meta-data could be registered to the message and can potentially be stored or communicated independently of the message.

Preferably, the method comprises determining an application accessible via the device that is capable of utilising at meta-data linked to a message and passing said meta-data to that application. Preferably, the application is a scheduling application such as a diary or calendar application. The application may be a mapping application. The application may be a voting, polling or opinion application.

Advantageously, the linking of meta-data to a message being composed enriches the message, enabling a number of functions to be performed on that message and/or the message to be translated into other forms. For example, the meta-data may be used to accurately translate the message into other languages. Furthermore, the meta-data may be used to facilitate the automatic porting of content of the message into other applications. This can improve the interoperability of the messaging composition interface with other applications, reducing the burden imposed on the user to duplicate the content already in a message. For example, a predefined multi-character expression may be an expression of time. Accordingly, meta-data associated with such an expression of time can be used to facilitate the porting of that expression to a diary application. Specifically, if a user types “I will meet you at 3 pm” (the “3 pm” expression being inserted via the appropriate GUI module), then the meta-data associated with “3 pm” enables a diary application to be populated with a reference to that meeting. Thus, a composed message—as well as being a message—can also serve to populate a diary application with a meeting. Advantageously, the meta-data is already predefined, and so semantic analysis of the message is not required to generate the meta-data, relieving the device of a computational burden that would otherwise need to be carried out for such semantic analysis. In other words, as a result of a user entering the expression “3 pm” via a GUI module that is semantically and intrinsically associated with an expression of time, the meta-data that is associated with “3 pm” can automatically be correctly linked to an expression of time, rather that in being inferred through semantic analysis—which can be prone to error.

Meta-data associated with a multi-character expression may comprise the graphical representation of that multi-character expression. Accordingly, this allows a message to be sent in combination with meta-data to enable a remote device to re-render the graphical representations of the text contained within the originally composed message.

It will be appreciated that the application that is capable of utilising the meta-data does not necessarily need to be local to the communication device—merely accessible by it. For example, the diary application accessible by the communication device may be located on a server remote from the communication device. However, an application that is local to the device has the advantage of not requiring a external communication link—thereby increase the speed at which the application can receive and process the meta-data.

The method may comprise receiving a message at the communication device, the received message being enriched with meta-data and/or containing at least one predetermined phrase for generating meta-data. The method may then comprise passing said meta-data (whether already contained in the received message and/or generated from predetermined phrases within the received message) to an application accessible via the device capable of handling that meta-data. Said passing of said meta-data may be dependent on a user-chosen reply to the received message.

Advantageously, this can enable the communication device to process meta-data relevant to said application in response to received meta-data. For example, if a message is received that includes an invitation to an event: “Do you want to come to a party, my house, tomorrow at 3 pm?”—then meta-data associated with the time and date of this event may be passed to the message recipient's calendar application. This may be done once a reply to that message is sent, confirming attendance. Similarly, meta-data associated with “my house” such as its geographical location, address etc, may be included and/or linked with the message, and could be passed to a message recipients mapping application enabling them to know precisely where “my house” is.

Preferably, the customisation module is configured to receive a user input to associate meta-data with a multi-character expression. For example, if a user has created a graphical representation assigned to the multi-character expression “my house”, the customisation module can also allow meta-data associated with that multi-character expression to be associated with this graphical representation and/or multi-character expression. As mentioned, such meta-data could include the geographical location of “my house”—for example, in a coordinate system compatible with a mapping application, the meta-data could include the address of “my house”.

Preferably, the method comprises displaying a preview of the user-specified multi-character expression to be inserted into the message. Ideally, the method comprises updating the preview concurrently with a user interaction with the graphical representations of the GUI module.

Advantageously, this provides a user with the option of receiving feedback as to whether the selection of a particular graphical representation (or set of graphical representations) will yield a suitable expression for insertion into the message being composed. Accordingly, the user can choose to discard, confirm or amend an expression prior to committing it to the message. Furthermore, the concurrent updating of the preview of the expression has the advantage to allow an expression to be amended by a user without necessarily completely discarding that message, saving user time in message composition. For example, if the user interacts with a GUI module to insert an expression of time such as “3 pm”—however wants to amend the expression to define a time range, it is possible to do so without discarding the original expression. In particular, interacting with other graphical representations associated with a range of time can modify the original expression (and let the user see how it is modified in real-time). Thus the expression “3 pm” can be amended to “from 3 pm” and then further amended to “from 3 pm to 4.30 pm”.

Preferably, an appropriate GUI module comprises graphical representations that define multi-character expressions of time.

Said graphical representations that define multi-character expressions of time may be arranged to define a time scale, the graphical representations being arranged to receive a user interaction with the time scale to specify a multi-character expression of time or set of times.

Said graphical representations may comprise a first GUI slider, user-positionable on the time scale to define a first point in time. Said graphical representations may comprise a second GUI slider, user-positionable on the time scale to define a second point in time. The first and second sliders may be user-positionable simultaneously on the time scale to define a time range.

Said graphical representations may be arranged to define a virtual clock, the graphical representations being arranged to receive a user interaction with the virtual clock to specify a multi-character expression of time or set of times. Advantageously, this provides an intuitive way in which a user can interact with a GUI module to specify an expression of time.

Said graphical representations may comprise a first set of GUI artefacts representing hours of the day. Said graphical representations may comprise a second set of GUI artefacts representing minutes of an hour. The second set of GUI artefacts may represent minutes of an hour spaced at five minute intervals (e.g. 00, 05, 10, 15, 20, 25, 30, 35, 40, 45, 50, 55). Said graphical representations may comprise a third set of GUI artefacts representing “a.m.” and “p.m.” periods associated with a twelve-hour clock convention. The first set of artefacts may be arranged circumferentially to emulate the positions of hours on a clock face. The second set of artefacts may be arranged circumferentially to emulate the positions of minutes on a clock face. The first and second set of artefacts may be arranged concentrically to one another. Ideally, the first and second set of artefacts define concentric dials. Preferably, the first set of GUI artefacts are disposed radially outside the second set of GUI artefacts. Preferably, the second set of GUI artefacts are disposed radially outside the third set of GUI artefacts.

Advantageously, the chosen set and arrangement of artefacts provides a user with an intuitive way in which to select a desired expression of time. In particular, the concentrically arranged artefacts representing hours of the day, minutes of an hour and whether it is before or after noon (a.m., p.m.) enables a user to specify a time by selecting, for example, an hour from the concentrically outermost dial, followed by the minutes past that hour from the dial within a concentrically inner dial, followed by which period of the day it is (a.m. or p.m.). The logical selection locations (from outer to inner) is easy to understand and so improves the speed at which a user can enter an expression of time. It will be understood that in alternatives, the sets of GUI artefacts may be arranged to receive user input other ways—for example, using other selection locations such as from inner to outer, or across from left to right.

Preferably, each set of artefacts are visually delimited from one another. Advantageously, this can enhance a users understanding of how to operate said artefacts, and to highlight the distinction between the different sets.

Preferably, the method may comprise receiving a user-selection of at least one GUI artefact from at least one of the first, second and thirds sets to thereby define a user-specified expression of time.

Advantageously, this arrangement can reduce the number of inputs that a user needs to provide specify a valid expression of time. In particular, if the user selects only a single GUI artefact from the first set, it is possible to construct a valid expression of time (e.g. “I will call you at 4 o'clock”). If the user selects only a single GUI from the second set, this also can serve to construct a valid expression of time (e.g. “I will call you in 45 minutes”). Similarly, the third set alone (a.m./p.m.) can also be used to construct a valid expression of time (e.g. “I will call you this afternoon”). In this latter case, user selection of the GUI artefact “p.m.” alone causes insertion of the multi-character expression “afternoon” into the message—as appropriate for the context of the message.

Preferably, repeatedly selecting one of such GUI artefact specifies a series of alternative multi-character expressions of time—for example “4 pm”, “16 hr00”, “four p.m.” etc. Advantageously, this allows a user to easily specify a preferred one of a plurality of time formats.

Preferably, the virtual clock is configured to allow a user to modify an expression of time. Said modification may comprise specifying a time range. Ideally, said time range is specified by receiving a user selection of multiple GUI artefacts, defining at least a start-point at end-point for that time range. For the avoidance of doubt, once a time range has been selected, a multi-character expression associated with said range may then be inserted into the message. For example “from 4 pm to 5 pm”.

The GUI module may comprise GUI artefacts associated with expression modifiers. Advantageously, this can provide the user with a means of modifying a multi-character expression, such as an expression of time.

Said GUI artefacts associated with expression modifiers may generate multi-character expressions to be inserted into a message when selected, but be semantically linked to a another multi-character expression. For example, expression modifiers may comprise the terms “from”, “to”, “before”, “after”, “until”, “by”, between”, “on”, “at”, “around” etc.

Expression modifiers may be linked to a particular semantic category. Advantageously, these modifiers enable construction of complex and complete sentences. Preferably, expressions modifiers can serve as a trigger to invoke other GUI modules.

Said GUI artefacts associated with expression modifiers may be user-selectable to define a numerical range—for example, a time range. For example, a GUI artefact associated with an expression modifier “between” requires a start-point and an end-point —e.g. “between 4 pm and 5 pm”.

Preferably, an appropriate GUI module comprises graphical representations that define multi-character expressions of date. Said graphical representations may be arranged to define a virtual calendar, the graphical representations being arranged to receive a user interaction with the virtual calendar to specify a multi-character expression of date. Advantageously, this provides an intuitive way in which a user can interact with a GUI module to specify an expression of date.

Preferably, said virtual calendar comprises a plurality of GUI artefacts, each representative of a date. For example, the GUI artefacts may represent numerals—each indicating a day in a month. Preferably, the virtual calendar comprises a month picker, for selecting a month (and/or the dates of that month) that the virtual calendar is to display. Preferably, the virtual calendar comprises a year picker, for selecting a year (and/or months of that year and/or dates of that year) that the virtual calendar is to display. Ideally, when the GUI module comprising a virtual calendar is invoked, the month and year displayed by default is that matching the date on which that GUI module is invoked.

Preferably, a user selection of one of such GUI artefacts specifies a multi-character expression of date to be inserted into the message. For example, selection of the GUI artefact representing the numeral “11”, whilst the virtual calendar displays “February” and “2013” will allow the multi-character expression “11th February 2013” to be inserted into the message.

Preferably, repeatedly selecting one of such GUI artefact specifies a series of alternative multi-character date expressions—for example “11-Feb-2013”, “11/02/13”, “Eleventh of February, Two-Thousand and Thirteen” etc. Advantageously, this allows a user to easily specify a preferred one of a plurality of date formats.

Preferably, the virtual calendar is configured to allow a user to specify a date range. Ideally, said date range is specified by receiving a user selection of multiple GUI artefacts, defining at least a start-point at end-point for that date range. For example, this may be implemented by a user dragging a path on the virtual calendar from a GUI artefact representing a start date to a GUI artefact representing an end date for the date range. Said virtual calendar may change appearance to highlight the dates selected within the range. Advantageously, this provides feedback to the user as to which date have been or are being selected within a range.

For the avoidance of doubt, once a date range has been selected, a multi-character expression associated with said range may then be inserted into the message. For example “from 11th to 21st of February”.

Preferably, the method comprises receiving a user-selection of a plurality of graphical representations to specify a respective plurality of multi-character expressions and automatically ordering said respective plurality of multi-character expressions in accordance with ordering rules within the message. Preferably, said ordering rules are grammatical rules. Advantageously, this can allow a user to select several multi-character expressions out of a normal grammatical sequence and this will be automatically corrected within the message to be sent. For example, if there are three graphical representations selected by the user “let's talk”, “evening”, “tomorrow”—in that order, the ordering rules could recognise that the message should be reordered to “Let's talk tomorrow evening”.

Preferably, the message composition interface is provided within a message composition interface pane displayed via the electronic display. Preferably message text is displayed via the electronic display within a text pane. Ideally, the text pane and the message composition interface pane are both displayed simultaneously to the user during message composition. Preferably, the message composition interface pane accommodates said virtual alphanumerical keyboard. Ideally, when the message composition interface is modified to replace said virtual alphanumerical keyboard with an appropriate GUI module, the appropriate GUI module is displayed to the user accommodated within the message composition interface. It should be noted that the replacement of the alphanumeric keyboard with the GUI module may occur at least in part.

Preferably, the method comprises remodifying the message composition interface to hide the GUI module when the text associated with the user-specified expression has been inserted into the message. In particular, the method may comprise reinvoking the virtual alphanumeric keyboard.

Preferably, the method comprises entering a space after each user-selected multi-character expression has been inserted into the message. Preferably, a space key is provided in a GUI module. Preferably, the method comprises reinvoking the virtual alphanumeric keyboard when the space key is selected by a user. Advantageously, this provides a fluid message composition experience. As a space does not need to be manually entered after each multi-character expression is entered by a user-selection of a graphical representation, the space key can be used for another purpose—to take the user back to the keyboard permitting character-by-character text input.

Preferably, the method may comprise a word or phrase auto-completion or prediction engine. Preferably, said engine is driven in response to the detected semantic category of a GUI module and/or may be based on the detected context of the message being composed.

According to a second aspect of the present invention there is provided a method of receiving user input to generate a text string on an electronic device, the method comprising:
providing the user with a text input interface for inputting text character-by-character;
modifying the text input interface to display to the user an appropriate GUI module comprising graphical representations of predefined multi-character expressions;
receiving a user interaction with at least one of said graphical representations of the GUI module thereby specifying at least one of said multi-character expressions to be inserted into the text string;
inserting text associated with the user-specified expression into the text string.

Preferably, the method comprises receiving a trigger, and in response modifying the text input interface to display to the user an appropriate GUI module. Ideally, user input is provided via a graphic user interface (GUI). Preferably, the text string is message text. Preferably, the electronic device is an electronic communication device. Ideally, the electronic device comprises a touch-sensitive electronic display. The text input interface may be provided via the electronic display. The text input interface may be a message composition interface. The text input interface may comprise a keyboard which may be a virtual alphanumeric keyboard. Ideally, the keyboard has keys configured to receive a user input for inputting text character-by-character. Preferably, the trigger is a user-driven trigger. The user-driven trigger may be the selection of a function key of the keyboard. Where the text input interface comprises a virtual alphanumeric keyboard, displaying to the user an appropriate GUI module may comprise replacing said virtual keyboard with the appropriate GUI module. A message can be a message suitable for transmission via a communication device. Preferably, the method comprises receiving a user command to transmit the message from the communication device to a remote device.

Preferably, the method of the first and/or second is executed on a or the mobile communication device.

According to a third aspect of the present invention there is provided a system arranged to carry out the method of the first and/or second aspect of the present invention. The system may be an electronic device such as a mobile electronic communication device.

According to a fourth aspect of the present invention there is provided a system arranged to receive a user input to generate a text string, the system comprising a text input interface for inputting text character-by-character and a GUI module comprising graphical representations of predefined multi-character expressions, the system being arranged to:
modify the text input interface to display the GUI module to the user;
receive a user interaction with at least one of said graphical representations of the GUI module thereby specifying at least one of said multi-character expressions to be inserted into the text string; and
insert text associated with the user-specified expression into the text string.

It should be appreciated that features of different aspects of the present invention may be combined where context allows.

### SPECIFIC DESCRIPTION OF THE EMBODIMENTS

Embodiments of the present invention will now be described, by way of example, with reference to the accompanying Figures.

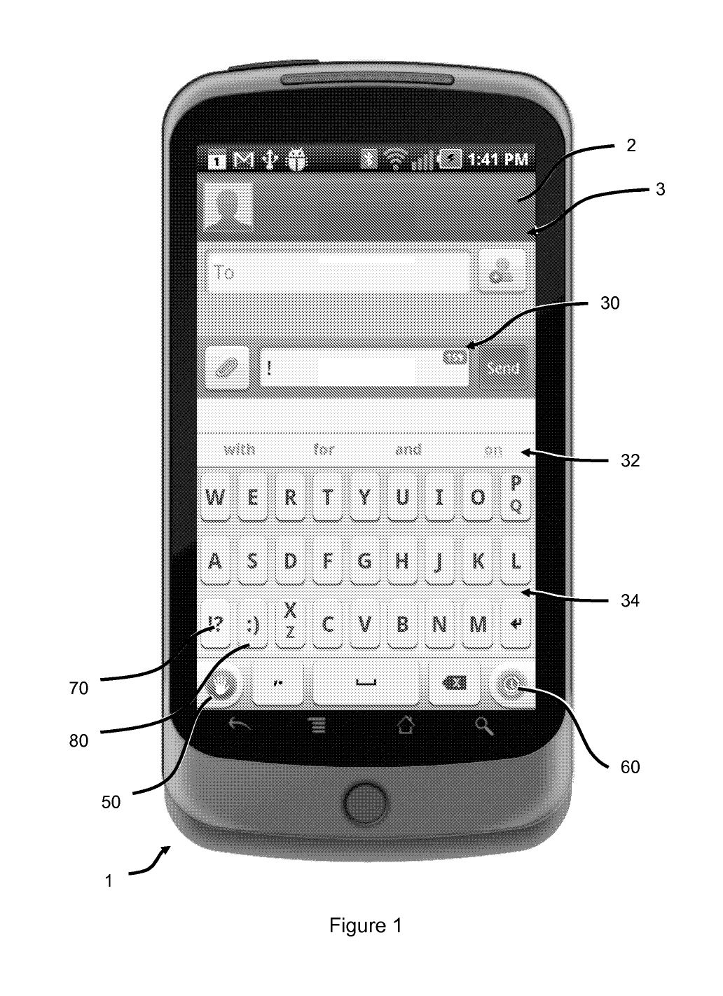

FIG. 1 shows an electronic mobile communication device 1 comprising a touch-sensitive electronic display 2 for displaying a user interface to a user and receiving input from the user. The electronic mobile communication device 1 is arranged to carry out a method of receiving user input to generate a text string. In particular, device 1 has a user interface that generates message text.

A message composition interface 3 is presented via the display 2 to a user. The message composition interface 3 comprises a text pane 30 in which generated message text is displayed to a user, a text suggestion pane 32 for suggesting text to be inserted into the message and a virtual alphanumeric keyboard 34 to allow a user to type a message character-by-character.

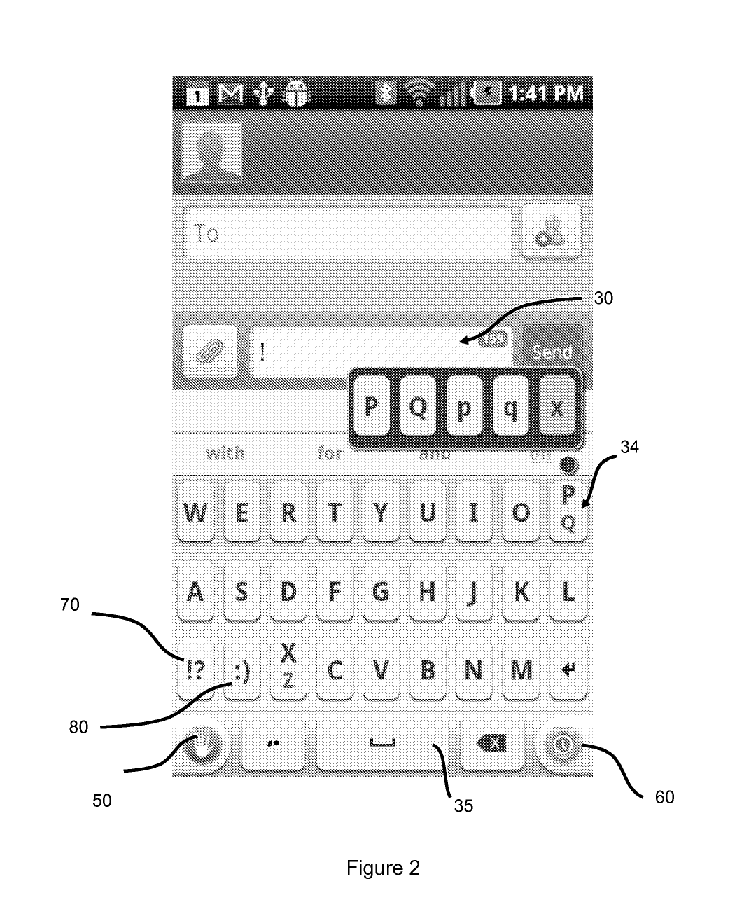

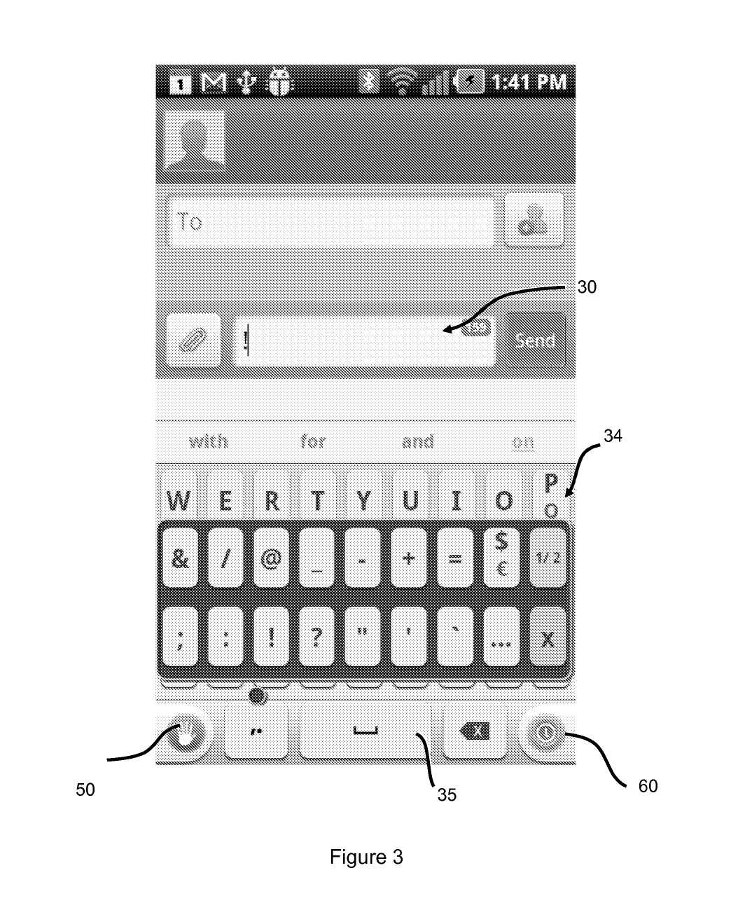

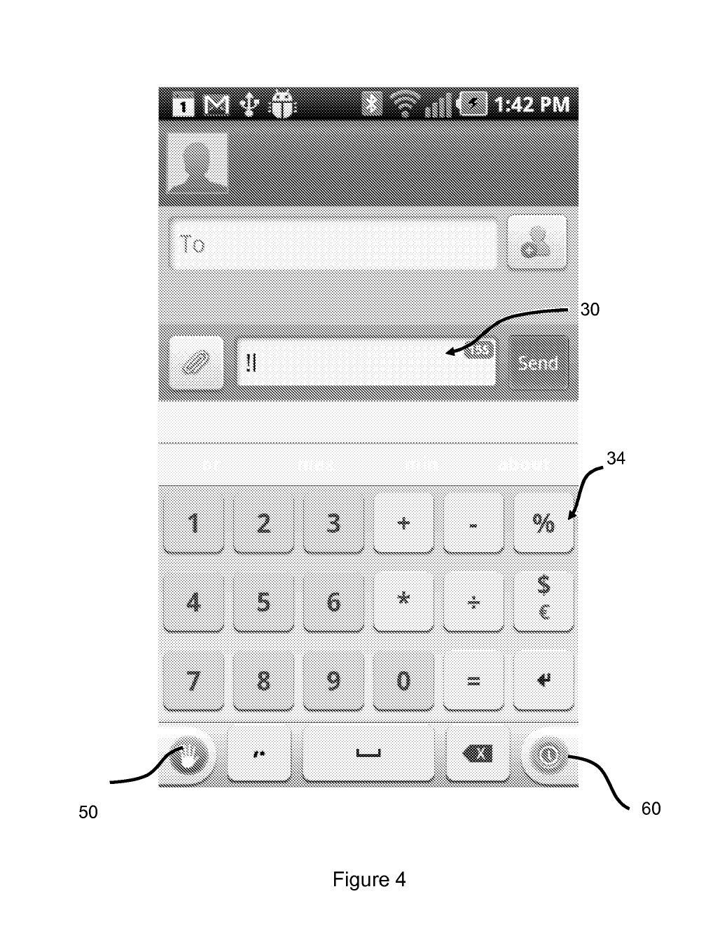

As is known in the art, a user can type in message text character-by-character via the virtual keyboard 34. As a user types on the virtual keyboard 34, the characters of the keys that the user has selected appear in the text pane 30. Certain less frequently used characters are grouped together, and are user-selectable accessible via a single key—for example, the “,.” key, the “p-q” key and the “x-z” key. These keys in particular may require a user to tap the key more than once to cycle through to the desired character. For example, a single tap of the “p-q” key will generate the letter “p”, a double tap will generate the letter “q”. As shown in FIG. 2, holding down the “p-q” key invokes a pop-up menu allowing a single tap selection of “P”, “Q”, “p” or “q” characters. A cancel (X) key cancels the menu. Similarly, a single tap of the “,.” key will generate a comma, a double tap will generate a full-stop, and long pressing the “,.” key will invoke a pop-up menu with a plurality of different characters for selection—as shown in FIG. 3. The virtual keyboard 34 can also be modified to show keys for different characters—for example numbers and numerical operators—as shown in FIG. 4.

The virtual keyboards 34 shown in FIGS. 1 to 4 share a common property, in that each key is assigned to an individual character. Thus, a user needs to press a key at least once to insert the appropriate character into the message. This method of text input is familiar to many users, and is highly flexible in terms of the words or phrases that can be generated. However, character-by-character text input can be relatively slow. A user's text entry speed be increased to some degree via selection of words suggested in the text suggestion pane 32. However, to further promote an increase in text entry speed, along with other advantages as will be described, the message composition interface 3 can be modified to invoke a plurality of GUI modules which enable a user to insert contextually relevant multi-character expressions into the message.

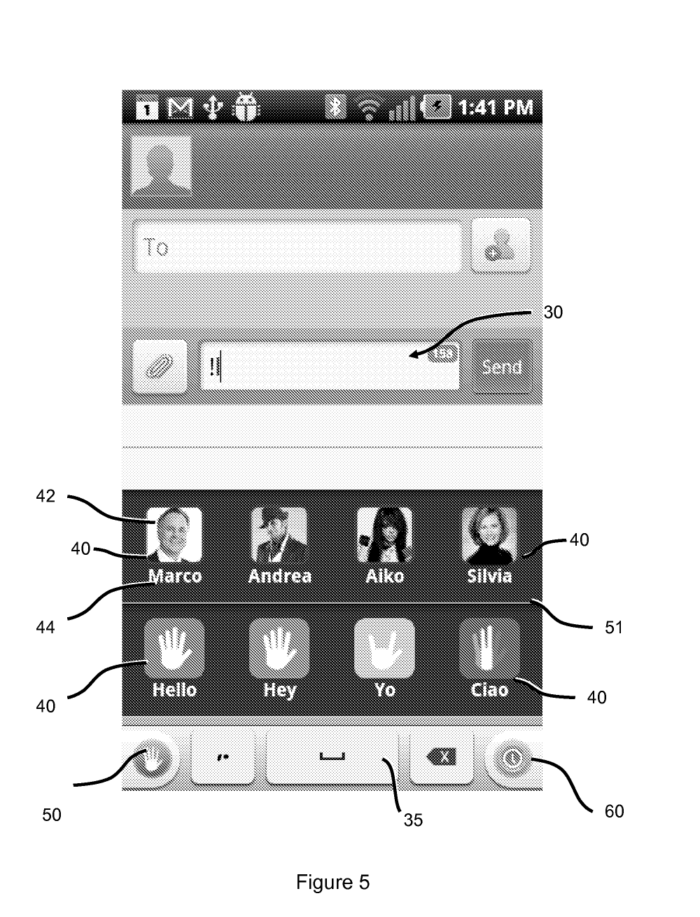

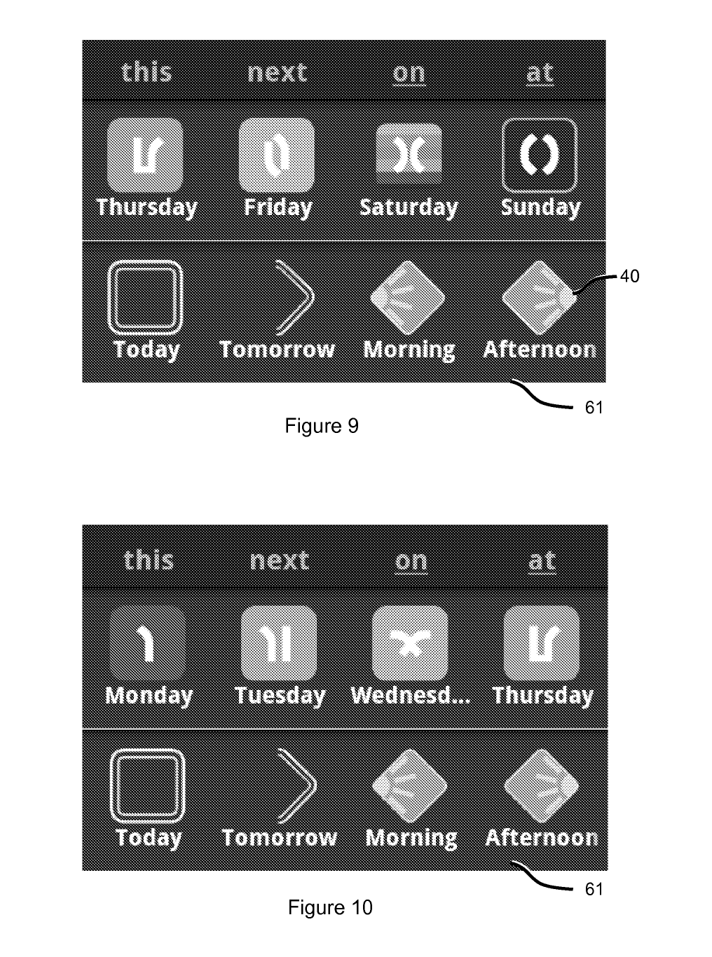

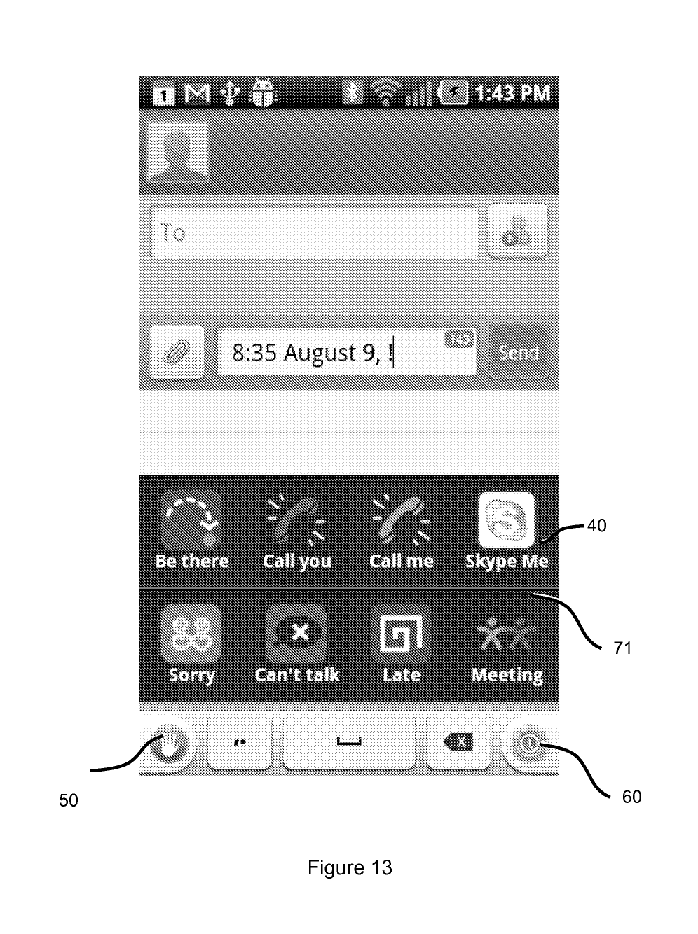

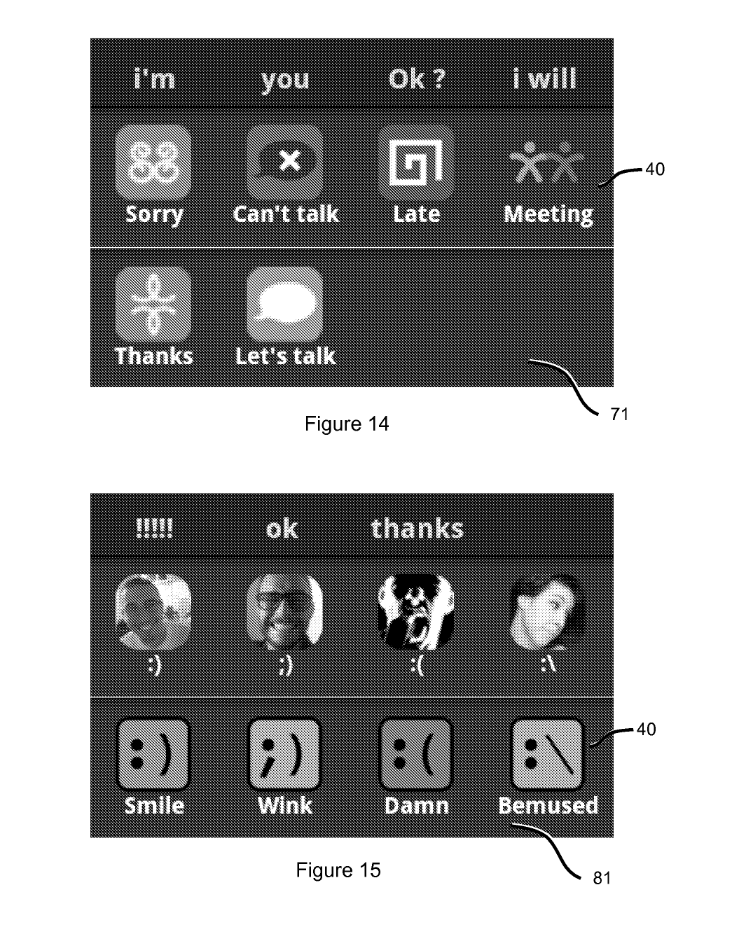

The message composition interface 3 comprises a first shortcut key 50, a second shortcut key 60, a third shortcut key 70 and a fourth shortcut key 80. A user selection of the first shortcut key 50 invokes a greetings GUI module 51 comprising graphical representations of multi-character expressions of greetings or sign-offs (goodbyes)—as illustrated in FIGS. 5 to 8. A user selection of the second shortcut key 60 invokes a time GUI module 61 comprising graphical representations of multi-character expressions of time—as illustrated in FIGS. 9 to 12. A user selection—via a long press—of the third shortcut key 70 invokes a pressured message GUI module 71—as illustrated in FIGS. 13 and 14. A user selection of the fourth shortcut key 80 invokes an emoticon GUI module 81—as illustrated in FIG. 15. Thus each GUI module is associated with a different predetermined semantic category. Other GUI modules may include those associated with activity, people, swearing etc.

FIG. 5 shows the invoked greetings GUI module 51. When invoked, the greetings GUI module 51 takes up the position of the standard alphanumeric keyboard 34 within the electronic display 2. Graphical representations 40 of multi-character expressions such as “Hello”, “Hey”, “Yo” and “Caio” which are in themselves greetings and are contextually relevant to the semantic category of “greetings” are shown in the lower half of the greetings GUI module 51. Graphical representations 40 of multi-character expressions of likely recipients of those greetings such as “Marco”, “Andrea”, “Aiko” and “Silvia” are shown in the upper half of the greetings GUI module—and are also contextually relevant to the semantic category of “greetings”. It will be noted that each graphical representation 40 comprises a non-textual component such as an icon 42 and a textual component 44 corresponding to the multi-character expression associated with the graphical representation 40

The greetings GUI module 51 can be user-manipulated to display additional greetings. For example, if a user holds and drags the lower half of the greetings GUI module 51 two places to the left, additional graphical representations 40 can be shown—as illustrated in FIG. 7. If the upper half of the greetings GUI module 51 is dragged, then additional greetings recipients such as “Girl”, “Brother”, “Amigo” and “Baby” can be displayed.

When a user selects one of these graphical representations 40, the associated multi-character expression is inserted into the message. Accordingly, the speed of text insertion is improved beyond mere character-by-character text input. Furthermore, as the user has invoked the greetings GUI module 51, the number of expressions that the user is likely to want to use will be limited to the semantic category associated with greetings. Thus, the likelihood of a user quickly finding the correct greeting, and recipient of that greeting is high, maximising text input speed. Furthermore, the use of non-textual components enhances the user interface improving the speed at which a user is able to correctly identify and select the desired greeting.

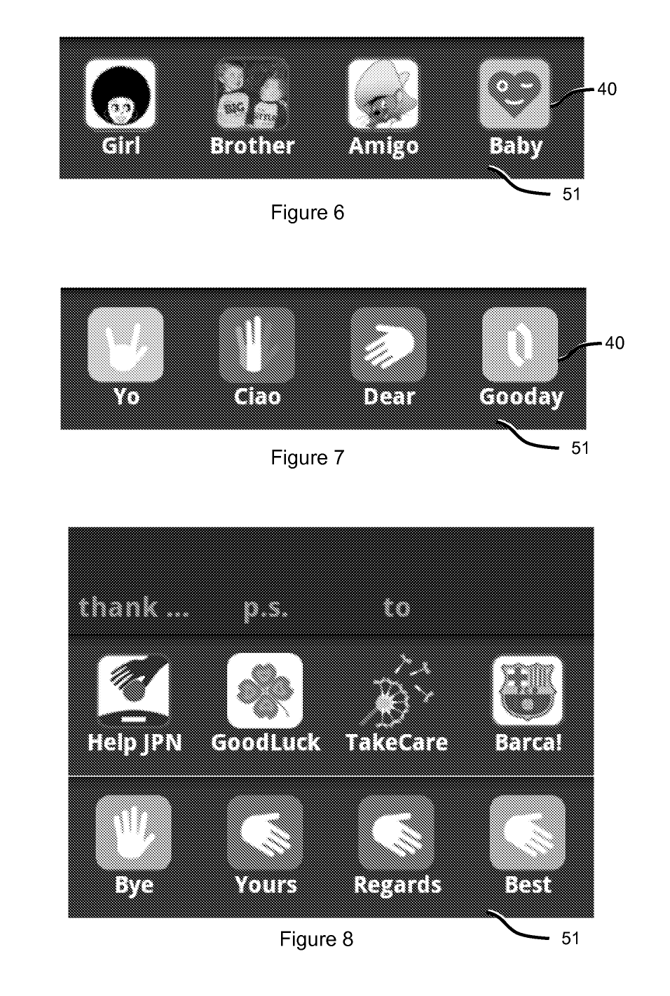

Furthermore, the greetings GUI module 51 changes the graphical representations displayed to the user following selection of one or more those graphical representations. In particular, if the greeting “Hello” is selected (and this text is inserted into the message), the lower half of the greetings GUI module 51 is likely to be redundant, as the greeting expression has already been provided into the message. Accordingly this triggers the greetings GUI module 51 to adapt to instead display additional message recipients in the lower half such as those depicted in FIG. 6. The user thus has a richer choice of recipients to direct the previously specified greeting. Once a recipient is selected, the greetings GUI module 51 may change further to display additional expressions such as phrases like “how are you?”, “what's up?” which are logical continuations of the original greeting. Thus, in three taps, a user can generate the message text “Hello brother, how are you?”—whereas normally this would require twenty-seven taps. It should be noted at after each word or expression generated via the graphical representations, a space is automatically inserted.

At any time, a user is able to return to using the standard virtual keyboard 34 by pressing the space key. Thus, after generating the text “Hello brother, how are you?” the user can continue composing text in the traditional way.

Towards the end of message generation, the user may want to sign off the message with a goodbye. Pressing the first shortcut key 50 again will invoke the greetings GUI module 51 again. However, as a greeting has already been inserted into the message, the greetings GUI module 51 instead presents the user with a set of sign-offs—as shown in FIG. 8.

Thus, the fluid transition between a character-by-character text input method (the virtual keyboard) and an appropriate GUI module provides the user with a message composition system that is both flexible and fast to use.

During message composition, if the user wants to insert an multi-character expression of time, the second shortcut key 60 can be selected, invoking the time GUI module 61 shown in FIG. 9. One or more of the graphical representations in the time GUI module 61 can be selected, and their associated multi-character expressions can be inserted quickly into the message. E.g. “this Friday afternoon”.

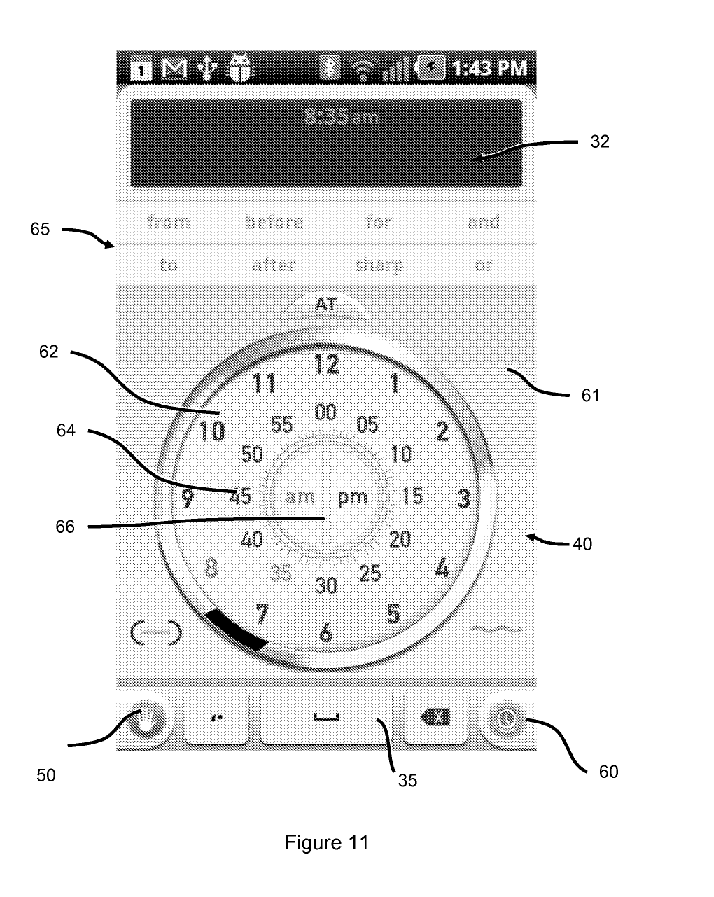

It should be noted that graphical representations 40 do not necessarily need to be in the form of icons. Referring to FIG. 11, the time GUI module 61 is shown arranged to receive an expression of time, in terms clock time or time of the day. Here, the graphical representations 40 are arranged to define a virtual clock which receives a user interaction to allow a multi-character expression of clock time to be expressed.

A first set of GUI artefacts 62 are arranged circumferentially to emulate the positions of hours on a clock face and so represent the hours of the day. Concentrically within the first set 62 are a second set of GUI artefacts 64 which are also arranged circumferentially and represent minutes past the hour, spaced at five minute intervals. Concentrically within both the first set 62 and second set 64 are a third set of GUI artefacts 66 representing “a.m.” and “p.m.” periods associated with a twelve-hour clock convention.

By interacting with these GUI artefacts, it is possible for a user to quickly and intuitively construct a valid expression of time. In particular, the concentrically arranged artefacts representing hours of the day, minutes of an hour and whether it is before or after noon (a.m., p.m.) enables a user to specify a time by selecting, for example, an hour from the concentrically outermost dial, followed by the minutes past that hour from the dial within a concentrically inner dial, followed by which period of the day it is (a.m. or p.m.). As can be seen in FIG. 11, the selections from each set of GUI artefacts are highlighted, and so define an multi-character expression “8:35 am”—which is displayed in an alternative text pane 32 above the virtual clock. Thus, the alternative text pane 32 provides a preview of the text, ready for insertion into the message.

More complex expressions of time are also possible using the expression modifier keys 65 located between the virtual clock and the alternative text pane 32. For example, if the “from” and “to” modifier keys are selected, an expression of a time range becomes possible—e.g. “from 8.35 am to 10 am”.

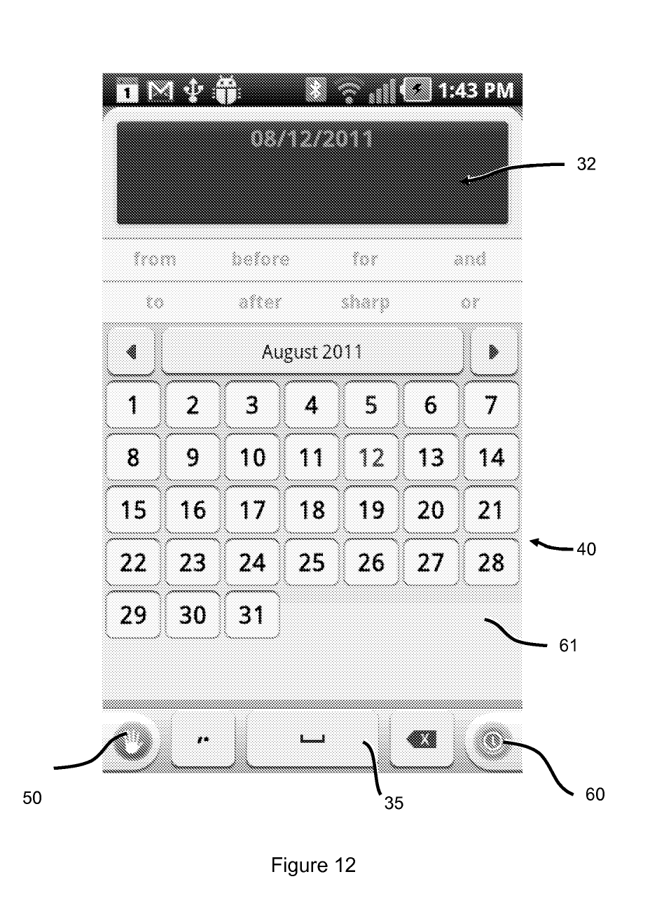

Referring to FIG. 12, graphical representations 40 can also be arranged to define a virtual calendar. A user interaction with the virtual calendar allows a multi-character expression of date to be inserted into the message in an intuitive way. In particular, said virtual calendar comprises a plurality of GUI artefacts with a unique numeral, each representative of a date, in particular a day in a month. In additional the virtual calendar comprises a month and year picker, for selecting which days of a month and a year to display. For example, a user selection of the GUI artefact “12” shown in FIG. 12 generates the multi-character expression “08/12/2011”, which is displayed in the alternative text box 32. This may be modified into a another format, for example “12 August 2011” by selecting that GUI artefact “12” again. Once a user is happy with the expression of date (and its format), this can be committed to the message as normal by pressing the space-bar key 35.

Referring to FIGS. 13 and 14, the “pressured message” GUI module 71 is shown. Like the greetings GUI module 51, this has a set of multi-character expressions that may be inserted into the message, these multi-character expressions being those which a user may typically need to communicate when they are under time pressure.

Similarly, the emoticons GUI module 81 shown in FIG. 15 displays a set of graphical representations 40 to a user which may typically be added to a message to convey emotion.

So far, the trigger for invoking an appropriate GUI module has been a user selection of one of the shortcut keys 50, 60, 70, 80. However, GUI modules, and moreover different graphical representations 40 of GUI modules may be invoked using other triggers. Alternatively, or in addition, the trigger may be automatic, the trigger being generated in response to analysing a message concurrently with message generation to detect a predetermined phrase therein. For example, if the predetermined phrase is “I'll be there by”, then an appropriate GUI module to be invoked is one allowing a user to insert an expression of time into the message.

An appropriate GUI module may also be invoked automatically in on selection of a particular key. For example, referring back to FIG. 1, the text suggestion pane 32 includes the suggestions “with”, “for”, “and” and “on”. The suggestion “on” is underlined which indicated that its selection will not only enter the text “on” into the message, but also invoke the time GUI module 61. Thus, a user might tap “on”—and then be able to quickly follow this with the multi-character expressions “Thursday” and “morning”.

As well as allowing messages to be composed quickly, the graphical representations 40 of multi-character expressions also serve another function. As each is unambiguously associated with a particular semantic category, it is possible to pre-associate accurate meta-data with each, increasing the informational content of the message at source. Thus as a message is being generated, meta-data associated with the message can also be generated and subsequently be used to enhance the utility of that message. For example, if a message contains text and meta-data associated with an expression of time, this can be utilised by a scheduling application. Alternatively, meta-data may allow a message to be unambiguously translated into other languages.

Thus, it can be seen that the present embodiment can simultaneously allow a user to enter text quickly (with multi-character expressions being insertable with a single tap) and also generate accurate meta-data about that text at source. This provides a significant improvement over prior known text generation systems.

1. A method of receiving user input via a graphical user interface (GUI) to generate message text on an electronic communication device comprising a touch-sensitive electronic display, the method comprising:
providing the user with a message composition interface via the touch-sensitive electronic display, the message composition interface comprising a virtual alphanumeric keyboard having keys configured to receive a user input for composing message text character-by-character;
modifying the message composition interface to display to the user an appropriate GUI module comprising graphical representations of predefined multi-character expressions;
receiving a user interaction with at least one of said graphical representations of the GUI module thereby specifying at least one of said multi-character expressions; and
inserting text associated with the user-specified multi-character expression into the message.

2. The method of claim 1, further comprising receiving a trigger, and in response modifying the message composition interface to display to the user an appropriate GUI module comprising graphical representations of predefined multi-character expressions, wherein the trigger comprises receiving a user selection of a function key of the message composition interface.

3. The method of claim 1, wherein the graphical representations comprise non-textual representations.

4. The method of claim 1, wherein the communication device is a mobile communication device.

5. The method of claim 1, wherein a user interaction with a graphical representation comprises repeatedly selecting the same graphical representation to specify a series of alternative multi-character expressions.

6. The method of claim 1, comprising displaying a customisation module to a user, the customisation module being configured to receive a user assignment of a graphical representation with at least one multi-character expression.

7. The method of claim 6, wherein the customisation module is configured to:
present to a user a library of graphical representations;
receive a user selection of a graphical representation within that library;
prompt the user to assign one or more multi-character expressions with said graphical representation selected from the library; and
add said assigned graphical representation to a GUI module for use in generating text during message composition.

8. The method of claim 6, wherein the customisation module comprises a GUI module editor arranged to receive a user input to create one or more personal GUI modules, said personal GUI modules comprising user-define graphical representations of multi-character expressions.

9. The method of claim 1, comprising determining multi-character expressions that are frequently inserted by a user into messages, automatically creating a graphical representation of that multi-character expression, and providing said automatically created graphical representation of that multi-character expression within an appropriate GUI module.

10. The method of claim 1, comprising receiving an automatic trigger for use in invoking an appropriate GUI module, the automatic trigger being generated in response to analysing a message concurrently with message generation to detect a predetermined phrase therein.

11. The method of claim 10, comprising learning said predetermined phrases, and associated GUI modules to be automatically invoked, from a user input via receiving a user-driven invocation of a given GUI module and logging message text entered prior to said user-driven invocation, said logged message text being used as a predetermined phrase for automatically invoking the given GUI module in future message composition.

12. The method of claim 1, wherein a GUI module is associated with a predetermined semantic category and comprises graphical representations of predefined multi-character expressions that are each semantically associated with the predetermined semantic category.

13. The method of claim 1, comprising amending text pre-entered character-by-character when a multi-character expression is user-specified via an appropriate GUI module.

14. The method of claim 1, wherein an appropriate GUI module comprises graphical representations that define multi-character expressions of time or date.

15. A system, such as a portable electronic communication device, arranged to carry out the method of claim 1.

16. A system, such as a portable electronic communication device, arranged to receive a user input to generate a text string, the system comprising a text input interface for inputting text character-by-character and a GUI module comprising graphical representations of predefined multi-character expressions, the system being arranged to:
modify the text input interface to display the GUI module to the user;
receive a user interaction with at least one of said graphical representations of the GUI module thereby specifying at least one of said multi-character expressions to be inserted into the text string; and
insert text associated with the user-specified expression into the text string.

17. A method of receiving user input via a graphical user interface (GUI) to generate message text on an electronic communication device comprising a touch-sensitive electronic display, the method comprising:
providing the user with a message composition interface via the touch-sensitive electronic display, the message composition interface comprising a virtual alphanumeric keyboard having keys configured to receive a user input for composing message text character-by-character;
modifying the message composition interface to display to the user an appropriate GUI module comprising graphical representations of predefined multi-character expressions of time, the graphical representations being arranged to define a virtual clock;
receiving a user interaction with at least one of said graphical representations of the GUI module thereby specifying at least one of said multi-character expressions of time; and
inserting text associated with the user-specified multi-character expression into the message.

18. The method of claim 17, wherein the graphical representations comprise at least one set of GUI artefacts, artefacts in a set representing one of: hours of the day, minutes of an hour and a.m./p.m. periods.

19. The method of claim 18, wherein the at least one set of GUI artefacts are arranged circumferentially to emulate a clock face.

20. The method of claim 17, further comprising receiving a user selection of multiple GUI artefacts defining at least a start-point and end-point of a time range, and inserting a multi-character expression associated with that time range into the message.
